(19) United States
(12) Patent Application Publication
(10) Pub. No.: US 2007/0228162 A1
(43) Pub. Date: Oct. 4, 2007

(54) Methods and systems for logging into automated content vending systems for content delivery to portable devices

(76) Inventor: Mark E. Phillips, Seattle, WA (US)

Correspondence Address: OLYMPIC PATENT WORKS PLLC, P.O. BOX 4277, SEATTLE, WA, 98104, US

(21) Appl. No.: 11/394,152

(22) Filed: Mar. 30, 2006

(51) Int. Cl. G06F 7/08

(52) U.S. Cl. 235/381; 235/383; 235/382

(57) ABSTRACT

One system embodiment of the present invention is a kiosk for retailing and distributing digitally-encoded content that features a card reader, such as a magnetic-stripe-card swipe reader or a smart-card reader, that allows a user to quickly and easily log into the kiosk using a credit card, retailer-provided identification card, or other card containing electronically readable information that identifies the user to the kiosk. Method embodiments of the present invention include methods for quickly and easily identifying a user and interconnecting with a user's portable device in order to prepare to provide any of a variety of personalized content-delivery services to the customer.

### TECHNICAL FIELD

The present invention is related to machine/human-user interfaces and, in several particular embodiments, to a kiosk interface for users to log into the kiosk and download content to one or more portable devices.

### BACKGROUND OF THE INVENTION

Relentless progress in the fields of consumer electronics, microelectronics, and electronic data-storage have led to an explosion of powerful and useful consumer-electronics devices that, among other things, store and render digitally-encoded content, including music and videos. As hardware capabilities have increased, and as the size of consumer-electronics-device components have continued to decrease, an increasing number of the powerful, new data-storage and rendering devices are portable. For example, currently available, portable music players allow owners of these devices to store thousands of digitally-encoded musical works within a device small enough to fit in a shirt pocket, to sort and categorize the musical works using sophisticated graphical user interfaces incorporated in the devices, and to play the musical works at extremely high fidelity. The development of these devices has, in turn, created large markets for purchasing and downloading digitally-encoded music files to portable devices. Although progress has been made in streamlining sales and delivery of digitally-encoded content, the market has expanded so quickly that many opportunities for distributing digitally-encoded content remain unexploited.

One promising approach for distributing digitally-encoded content, including music files and video files, involves retaining digitally-encoded content through automated kiosks within retail environments. Kiosks provide an extremely low-maintenance, low-footprint retailing and distribution system that may allow existing retailers that currently retail a variety of goods and services unrelated to digitally-encoded content to begin providing digitally-encoded-content-delivery services. As one example, food and beverage service providers may currently broadcast entertainment to their patrons. By adding a content-delivery kiosk to their retail establishments, the food and beverage service providers may, with very low cost and space overhead, begin to sell and distribute music and video content to portable devices carried and used by their customers. However, past failures in automated retailing of various products have convinced digitally-encoded-content retailers that, to be successful, an automated kiosk must provide time-efficient and intuitive interfaces in order to attract and maintain a sufficiently large customer base to justify even a relatively minimal the investment in kiosks and related technologies. For example, because of the multitude of different types of portable devices to which content may be downloaded, and because of the need to properly license, and to otherwise protect, the intellectual property rights of content owners, the process by which a user logs into a kiosk may be complex and time consuming. Manufacturers of kiosks, content retailers, and content purchasers have therefore all recognized a need for a streamlined and simplified log-in procedure to allow users to quickly interface with, purchase content from, and download content from, kiosks.

### SUMMARY OF THE INVENTION

One system embodiment of the present invention is a kiosk for retailing and distributing digitally-encoded content that features a card reader, such as a magnetic-stripe-card swipe reader, bar-code reader, or a smart-card reader, that allows a user to quickly and easily log into the kiosk using a credit card, retailer-provided identification card, or other card containing electronically readable information that identifies the user to the kiosk. Method embodiments of the present invention include methods for quickly and easily identifying a user and interconnecting with a user's portable device in order to prepare to provide any of a variety of personalized content-delivery services to the customer.

### BRIEF DESCRIPTION OF THE DRAWINGS

FIG. 1 shows an exemplary kiosk for automated retailing and distribution of content that represents one system embodiment of the present invention.

FIGS. 2A-E, 3, and 4 show three different methods, respectively, by which a user can quickly and easily log into a kiosk and which represent method embodiments of the present invention.

FIGS. 5A-B illustrate a final portion of a log-in process, representing a method embodiment of the present invention, that is common to all three log-in method embodiments of the present invention illustrated in FIGS. 2A-E, 3, and 4, respectively.

### DETAILED DESCRIPTION OF THE INVENTION

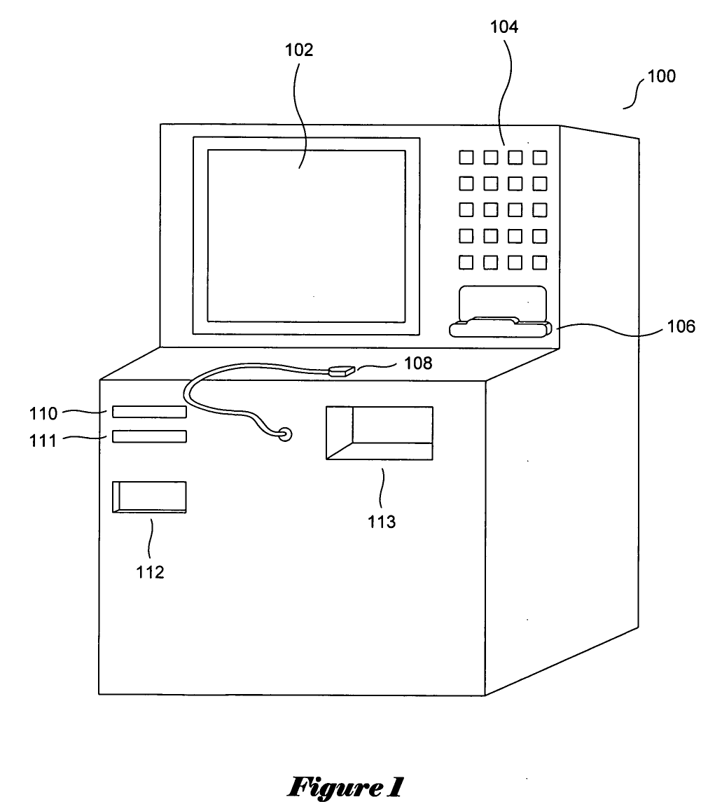

FIG. 1 shows an exemplary kiosk for automated retailing and distribution of content that represents one system embodiment of the present invention. As shown in FIG. 1, the kiosk 100 includes: (1) a display screen 102 for displaying user interfaces, content, and other information; (2) one or more various user-input means 104, such as a key pad, touch screen, or other input means; (3) a card reader 106; (4) an electronic port 108, such as a USB connector; (5) compact-disk trays 110-111; and (6) various additional ports and/or receptacles for various types of portable devices 112-113. A wide variety of different kiosk implementations that represent system embodiments of the present invention are possible. For example, the user input means may be created with the display screen 102 when the display screen has touch-screen capabilities. As another example, a kiosk may feature a much wider variety, and greater number, of ports and other electronic connections to allow users to connect many different portable devices of different types. Internally, the kiosk includes at least one processor, memory, an operating system running on the one or more processors, one or more mass storage devices, typically one or more communications links that link the kiosk with a central content storage and distribution system, and a kiosk control program. Kiosk embodiments of the present invention all include some type of card reader to facilitate time-efficient and easy access by users to content-purchase and content-delivery services provided by the kiosk. The kiosk operating system, generally in conjunction with a centralized, remote content-storage and content-distribution system, implements any of a variety of method embodiments of the present invention to allow a user to log into the kiosk using one of various types of cards that store digitally-encoded identification information in order to identify the user and quickly provide access to a variety of content-distribution services.

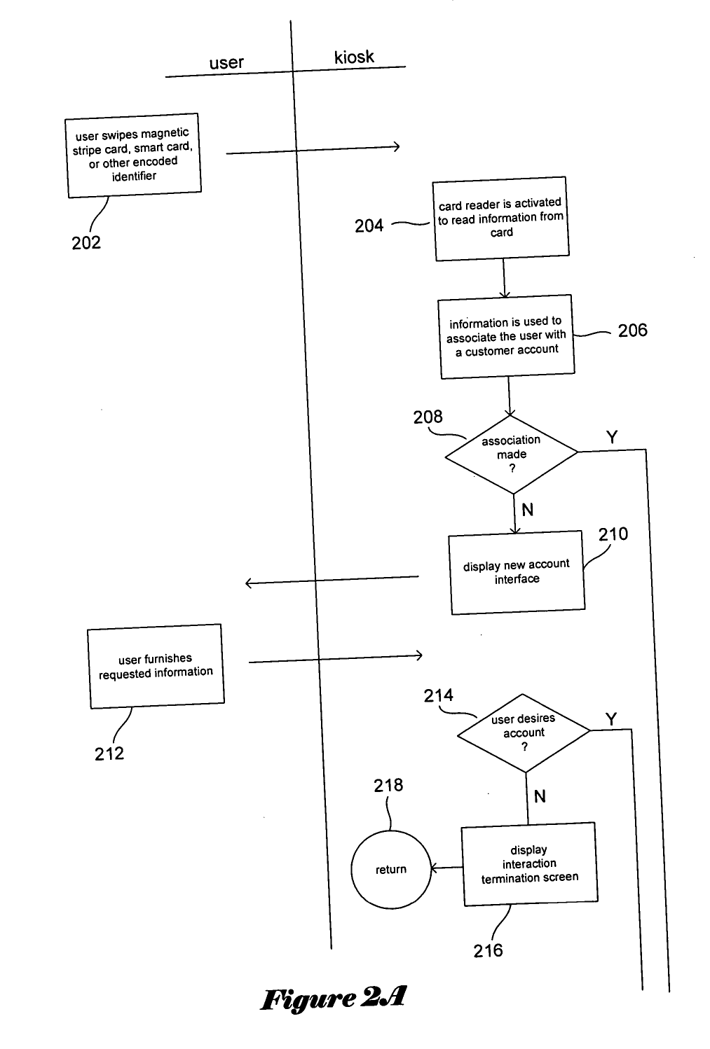

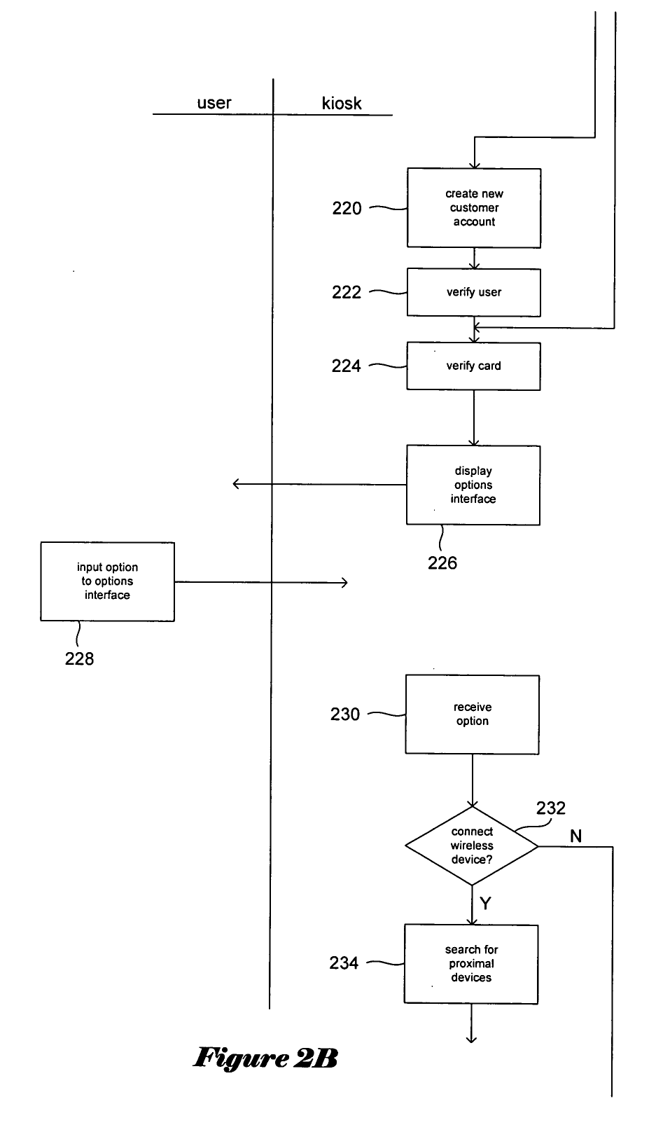

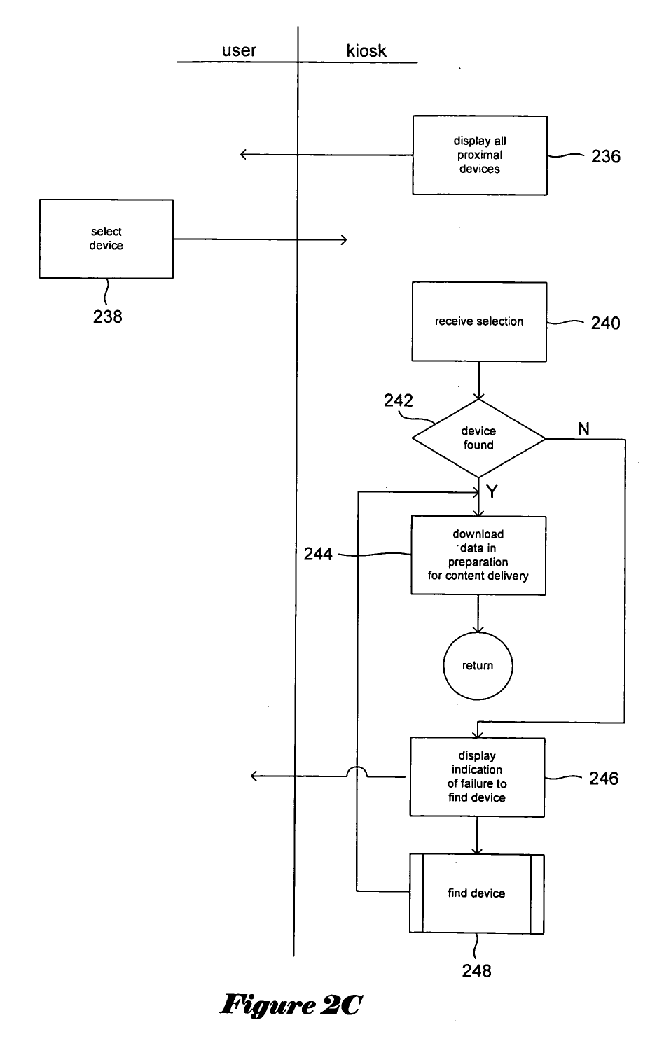

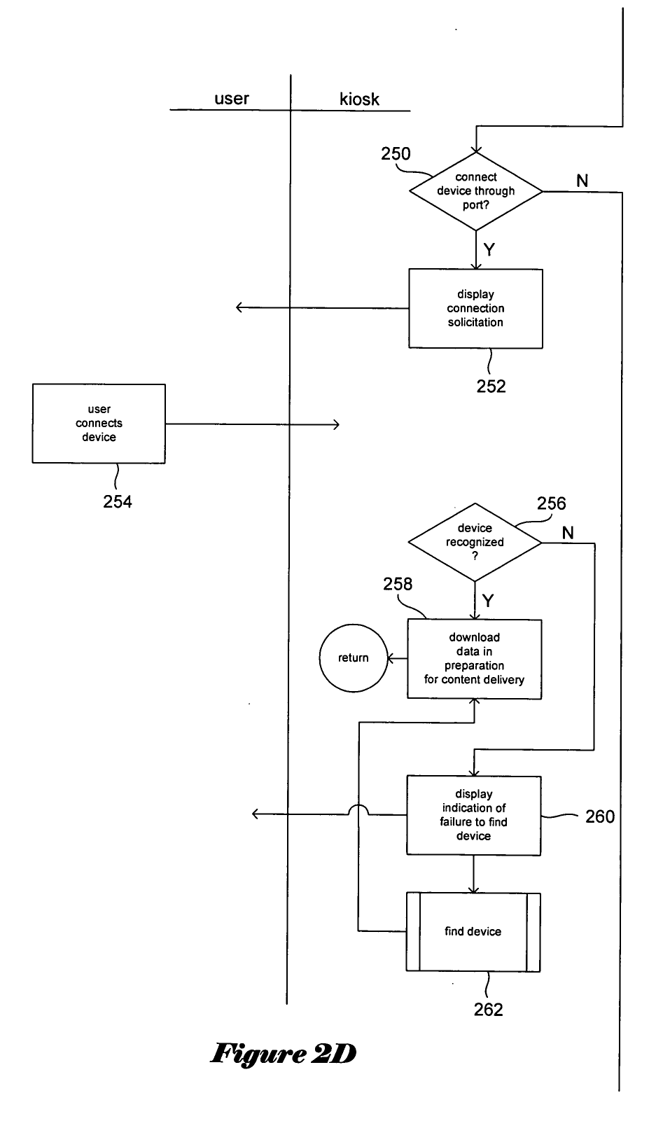

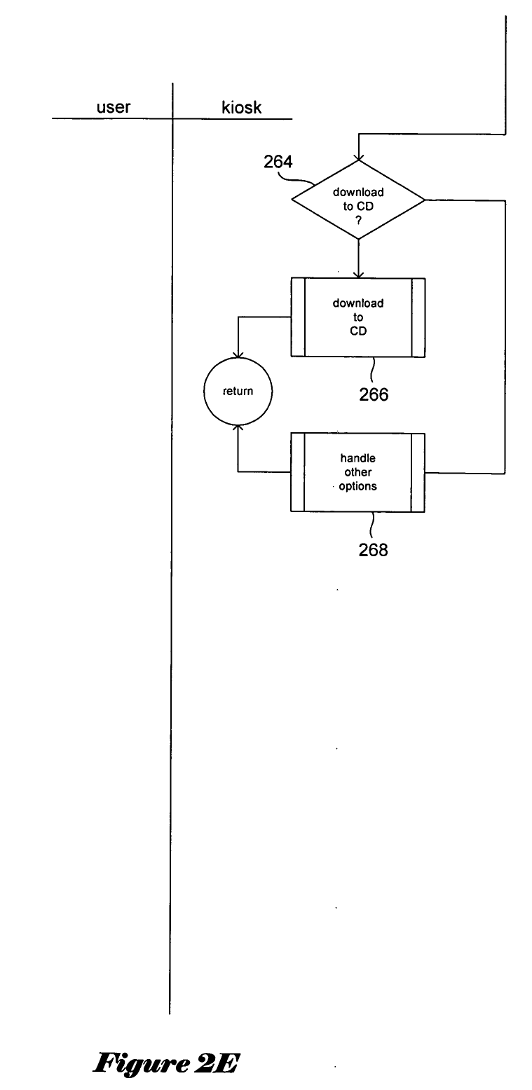

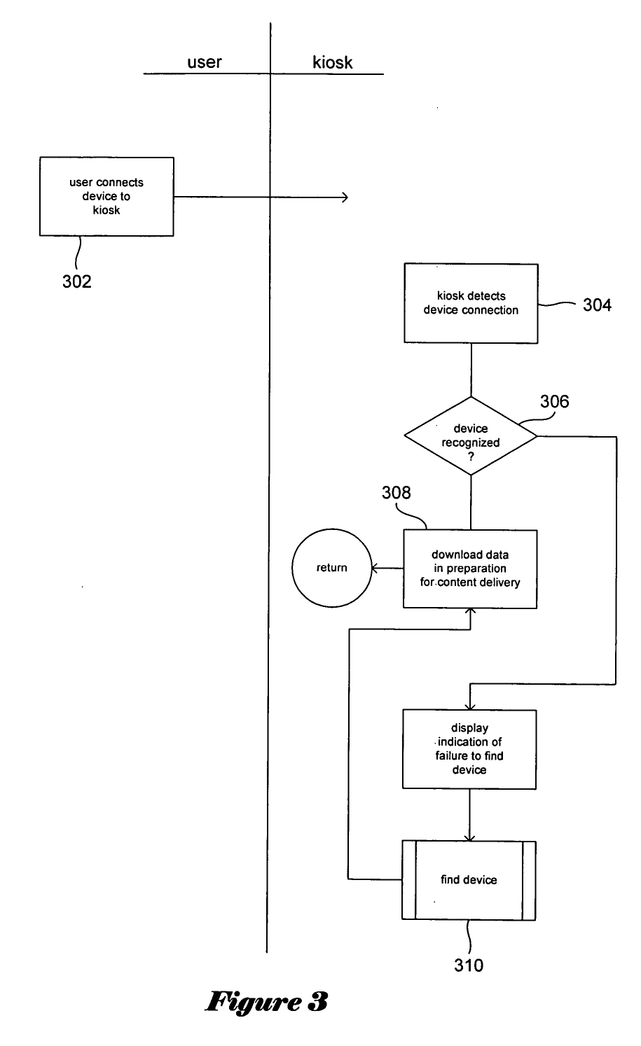

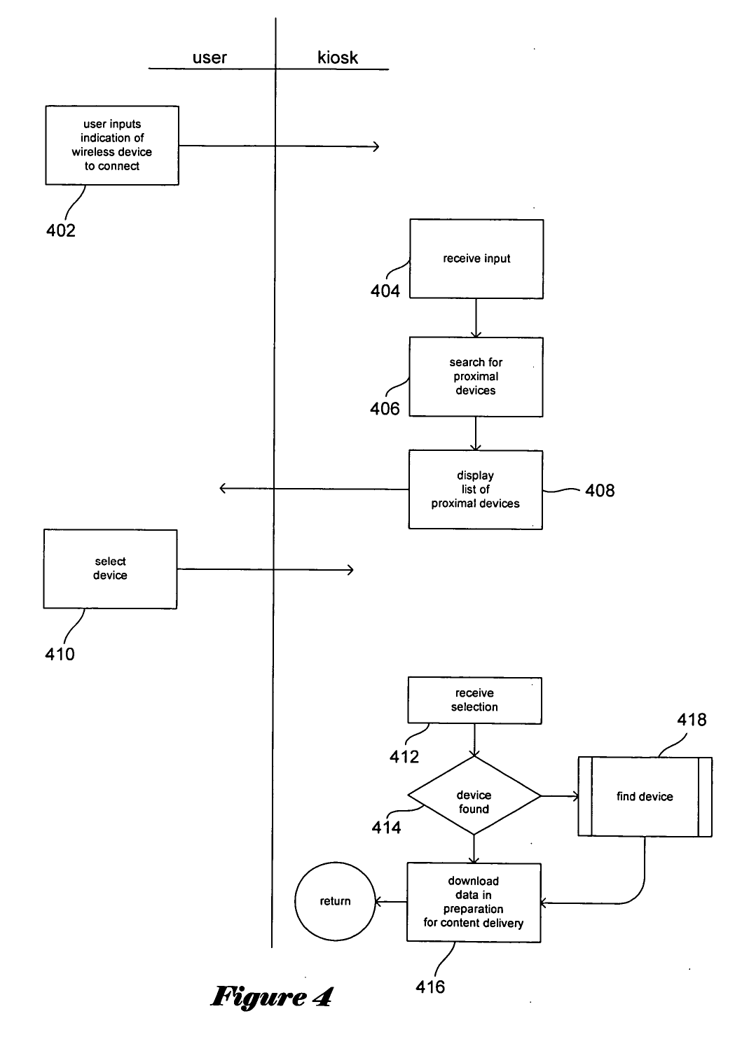

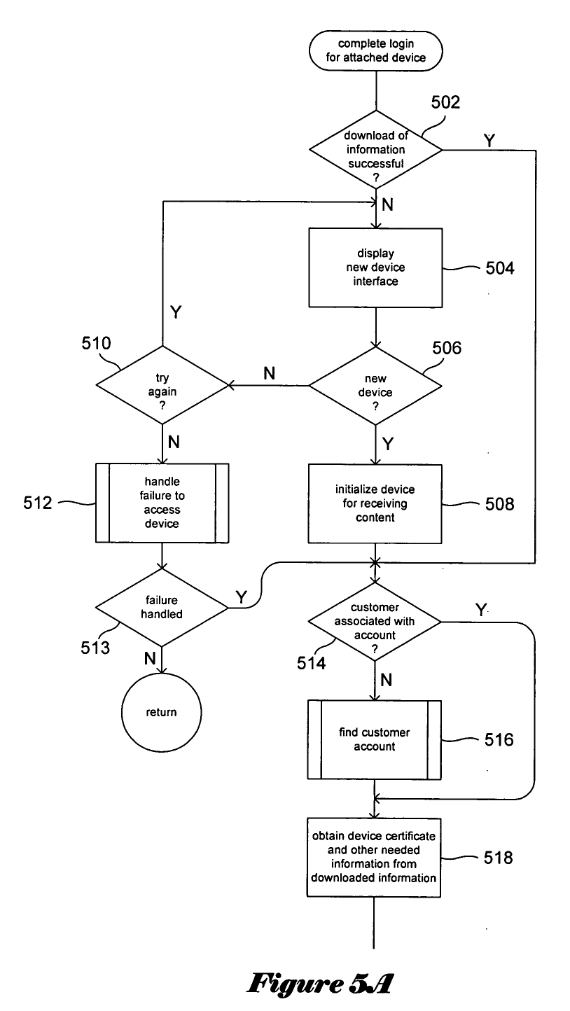

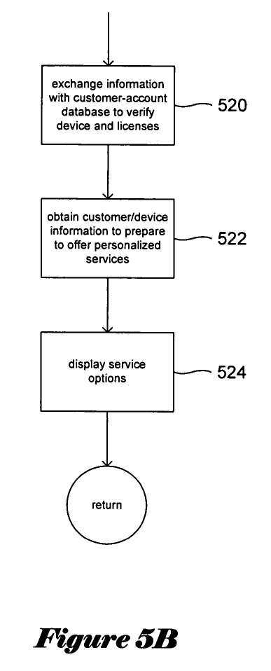

FIGS. 2A-E, 3, and 4 show three different methods, respectively, by which a user can quickly and easily log into a kiosk and which represent method embodiments of the present invention. FIGS. 5A-B illustrate a final portion of a log-in process, representing a method embodiment of the present invention, that is common to all three log-in method embodiments of the present invention illustrated in FIGS. 2A-E, 3, and 4, respectively.

FIGS. 2A-E show a control-flow diagram for a user log-in method involving input of user-identification information via one of various types of cards, including magnetic-stripe cards, such as credit cards, smart cards, bar codes, and other types of identification devices that encode digital user-identification information in a machine-readable form. In FIGS. 2A-E, as well as in FIGS. 3 and 4, control flow is divided between the user, actions of which are shown on the left-hand portion of the figures, and the kiosk, steps executed by which are shown on the right-hand portion of the figures. Kiosk actions are undertaken by a kiosk control program running above the kiosk operating system and computing hardware within the kiosk. In step 202, a user approaches the kiosk with a card, such a magnetic-stripe card or smart card, or a card or other object imprinted with a bar code, and transfers information from the card to the kiosk via a card reader (e.g. 106 in FIG. 1). Many different types of card readers for many different types of cards may be used for the kiosk interface. The card reader 106 shown in FIG. 1 is a swipe-type card reader frequently used at supermarket checkout counters. Reading of the card by the card reader either interrupts the kiosk control program or is detected by the kiosk control program by polling. The kiosk control program, in step 204, initiates transfer of user-identification information from the card reader into memory accessible by the kiosk control program. Then, in step 206, the kiosk control program uses the user-identification information to associate the user's card with a customer account. The association may be carried out entirely within the kiosk, by accessing a locally stored customer database, or more typically involves a kiosk control program transmitting the user-identification information to a remote retailing and database server that responds with customer-account information corresponding to the user identified by the user-identification information obtained from the user's card. The kiosk control program, in step 208, determines whether or not an association has been made between the user and a customer account in step 206. If no association has been made, the kiosk, in step 210, may display a new-account interface to allow a user, in step 212, to furnish information in order to establish a new account. If, upon receiving a user's input response to the new-account interface, the kiosk determines that the user does not wish to establish a new account, in step 214, then the kiosk may, in step 216, display an interaction termination screen of some type and return 218, terminating the log-in process. There may be additional conditional logic associated with detecting lack of an association between a user and customer account information. For example, an additional interface, not shown in FIG. 2A, may be used to diagnose the failure to find an association between the user-supplied user-identification information and an existing customer account, including misreading of the user's card, expiration of the user's card, and other such failures.

When the user does desire a new account, as determined in step 214, then, in step 220 of FIG. 2B, the kiosk control program creates a new customer account, typically interacting with a remote server to establish the new account, and then, in step 222, undertakes user verification. User verification may involve the kiosk alerting a human sales representative or retailer to interact with the user and verify the user's identity or, alternatively, may involve additional exchange of information, such as passwords, identification through various biometrics-based techniques, or other user-verification techniques. Next, whether logging in through an existing customer account or through a newly established customer account, the kiosk control program, in step 224, verifies the card used by the customer to initiate the log-in process. Card verification typically involves accessing a centralized card-management facility to independently verify that the card belongs to the user, that the card is valid, that the account authorizes purchase of content by the user, and other such information. Should either user or card verification steps fail, verification methods not shown in FIGS. 2A-E may be invoked to provide for logging in through alternate identification, for providing additional identification information, and for other failure handling steps.

Upon card verification, the kiosk may next display an options interface, in step 226. The user inputs an option selection to the options interface, in step 228, which is then received by the kiosk control program, in step 230. The kiosk control program determines, in step 232, whether the user has selected an option to connect to the kiosk via a wireless portable device. If so, then in step 234, the kiosk control program undertakes an automated search for all wireless devices accessible by the kiosk within some threshold radius, or distance, from the kiosk. The kiosk control program, in step 236, then displays a list of all wireless devices found to the user, who, in step 238, selects, from the list, the listed device corresponding to the user's device. The kiosk control program receives the user's selection, in step 240, and then attempts to interact with the wireless device to prepare to offer content-delivery services. If the kiosk control program has successfully interacted with the device, as determined in step 242, then the kiosk control program downloads digitally encoded data from the device in preparation for content delivery, in step 244. Otherwise, the kiosk control program may display an indication of failure to find, or interact with, the selected device, in step 246, and then undertake a device-finding process, in step 248, in order to interconnect with a portable device suitable for content delivery to the user. This process may involve requesting the user to correct a mistaken selection, in step 238, or may involve diagnosing a failure to properly connect to the selected device. Once a device is found, then information is downloaded from the device in preparation for content delivery, in step 244.

If, in step 228, the user selects an option to connect the user's portable device through an electronic port or device receptacle, as determined in step 250 of FIG. 2D, then, in step 252, the kiosk control program displays a connection solicitation interface to the user who, upon receiving the connection solicitation, connects the user's portable device to an electronic port, such as a USB port, in step 254. When connection of the device is recognized by the kiosk control program, in step 256, then, in step 258, the kiosk control program downloads data from the connective device in preparation for content delivery. Otherwise, the kiosk control program, in step 260, displays an indication of the failure to connect to the device and undertakes a device-finding process in step 262.

If, in step 228, the user selects an option to download content to a CD, as determined by the kiosk control program in step 264 of FIG. 2E, then the kiosk control program undertakes a process to identify content for downloading, and downloads the content to a writeable CD, in step 266. Otherwise, if there are additional options, then selection of any of the additional options are handled by an additional-options-handling process in step 268. Thus, the log-in method illustrated in FIGS. 2A-E generally allows a user to log into the kiosk using a magnetic-stripe card, smart card, or other such information-containing card, such as a card imprinted with a bar code, and to connect a portable device to the kiosk for downloading content.

Rather than logging into the kiosk using a magnetic-stripe card, smart card, or other type of small, information-containing object, a user may log-in to the kiosk by connecting a portable device to the kiosk. FIG. 3 shows a control-flow diagram for user log-in by connection of a portable device to an electronic port supplied by the kiosk. In step 302, the user approaches the kiosk and interconnects a portable device to the kiosk through an electronic port, device receptacle, or other interconnection means. In step 304, the kiosk control program detects the connection. The kiosk then attempts to interact with the connected device. If the kiosk control program recognizes the device, as determined in step 306, then the kiosk control program downloads data from the device in preparation for content delivery, in step 308. Otherwise, the kiosk control program undertakes a find-device process, in step 310, in order to successfully interconnect with a user's device. The find-device process may involve instructing the user to connect the device to another port, interact with the user to diagnose connection programs, recommend connection of an alternate device, and other such steps.

As a third log-in alternative, a user may log in through a wireless portable device. FIG. 4 shows a control-flow diagram for a wireless-device-based user log in that represents one log-in method of the present invention. In step 402, the user inputs an indication to the kiosk of a desire to log in via a wireless device. This may involve touching a button or touch-screen display or, in certain implementations, may merely involve approaching the kiosk with a wireless device that is automatically detected by the kiosk control program when the device comes within a certain distance of the kiosk. In step 404, the kiosk control program receives the user's input and, in step 406, searches for wireless devices within a threshold distance to the kiosk. In step 408, the kiosk displays a list of wireless devices found, from which the user selects the device corresponding to the user's device, in step 410. Upon receiving the user's selection, in step 412, the kiosk determines whether or not the kiosk can successfully interconnect with the device. If so, as determined in step 414, then data is downloaded from the device in preparation for content delivery in step 416. Otherwise, a find-device process is carried out, in step 418.

A kiosk may also support other, less streamlined log-in methods and interfaces. For example, a user may be allowed to interact with a kiosk via a log-in dialog and keyboard or touch-screen input in order to provide user identification and other information necessary to complete a log-in process. However, as discussed above, such traditional log-in methods are generally slow and potentially frustrating for busy and easily distracted consumers.

Once a portable device has been initially successfully interconnected with the kiosk, by any of the three log-in methods discussed above with reference to FIGS. 2A-E, 3, and 4, respectively, then a log-in process can be completed. FIGS. 5A-B show a control-flow diagram for the final portion of a log-in process that represents one embodiment of the present invention. First, in step 502, the kiosk determines whether or not download of information from the connected portable device was successful. If not, then the kiosk control program may assume that a new device has been connected to the kiosk and display a new-device interface, in step 504, in order to interact with the user to determine whether or not the user wishes to configure a new portable device for content delivery from the kiosk. If so, as determined in step 506, then the kiosk control program initializes the new device, in step 508. Otherwise, the kiosk control program may elect to again try to detect a new device, in step 510, or to otherwise handle a failure to access the user's portable device, in step 512. The failure-handling process of step 512 may involve diagnosing the failure in a dialog with the user, directing the user to try a different portable, or involve other such activities. If the failure is successfully handled, as determined in step 513, the log-in process may continue, and may otherwise terminate.

If the customer has not yet been associated with a customer account, as determined in step 514, then the kiosk control program undertakes a process, in step 516, to find a customer account associated with the user. Once the kiosk control program can successfully interact with the user's portable device, and the user has been successfully associated with a user account, the kiosk control program, in step 518, obtains a device certificate and any other information needed by the kiosk control program, from the information downloaded from the device, in order to provide content-distribution services to the user. The device certificate may be any of different types of electronically encoded information that authorizes the user to purchase and receive electronically encoded content. The device certificate may indicate that the user has agreed, in advance, to license fees and to adhere to license terms. Device certificate formats may be specified within various transport protocols and secure-transfer standards. Next, in step 520, the kiosk control program verifies the device certificate and other information with a remote customer-account database to verify the user's ability to download content. In step 522, the kiosk control program obtains additional customer/device information from the information downloaded from the device, or by accessing the device to obtain further information, in order to prepare to offer personalized content-purchasing and content-delivery services to the user. Finally, in step 524, the kiosk control program displays various service options to the user to select any of the various content purchasing and content-distribution services offered by the kiosk. At this point, log in has been successfully achieved.

Although the present invention has been described in terms of particular embodiments, it is not intended that the invention be limited to these embodiments. Modifications within the spirit of the invention will be apparent to those skilled in the art. For example, an almost limitless number of different interfaces can be implemented to facilitate the exchange of information between the user and the kiosk needed to log in the user and obtain sufficient information to provide personalized content-purchase and content-distribution services to the user. The kiosk control program can be implemented in any number of different computer programming languages, using any number of different organizations, control structures, data structures, and other programming parameters. Although described embodiments of the present invention involve a streamlined and easy log-in process facilitated by magnetic-stripe cards, smart cards, and other such digital-information-containing card-like objects, many additional means of providing digitally encoded user-identification information may be employed in alternative embodiments.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A system for automated retailing and distribution of digitally-encoded content, the system comprising:
a control program running above an operating system and a hardware platform including at least one processor, memory, and at least one mass-storage device;
a display for displaying user interfaces, under control of the control program, to facilitate retailing of digitally-encoded content to users;
at least one user input means to allow users to respond to displayed user interfaces;
a reader that reads digitally-encoded information from a user's identification-information-containing card or other information-containing object during user log-in;
at least one electronic port for connection of a portable device to the system to facilitate transfer of digitally-encoded content from the system to the portable device; and
a wireless-device communications means for discovering and communicating with nearby wireless devices.

2. The system of claim 1 wherein a user initiates log-in into the system by swiping a magnetic-strip card through the reader.

3. The system of claim 1 wherein a user initiates log-in into the system by placing a smart card into the reader.

4. The system of claim 1 wherein a user initiates log-in into the system by placing a bar-code imprinted object into the reader.

5. The system of claim 1 wherein a user initiates login-in into the system by connecting a portable device to the electronic port.

6. The system of claim 1 wherein a user initiates login-in into the system by carrying a wireless device into communications range of the wireless-device communications means.

7. The system of claim 5 further including input, by the user, of an indication of a desire to log-in via a wireless device to the user input means.

8. A method for logging a user into an automated retailing and distribution system that retails and distributes of digitally-encoded content and that includes a reader, the method comprising:
receiving user-identification information read by the reader from a user's card or other information-containing object;
accessing a customer data base to associate the user-identification information with a customer account; and
obtaining information from the customer account for facilitating validation of the user and for providing content-purchase and content-distribution services to the user.

9. The method of claim 8 further including accessing a centralized card-management facility to verify the user's card.

10. The method of claim 8 wherein the card is one of a magnetic-stripe card and a smart card.

11. The method of claim 8 further including prompting the user to connect a portable device with the automated retailing and distribution system on which to download content.

12. The method of claim 11 wherein the user connects a portable device to an electronic port of device receptacle provided by the automated retailing and distribution system.

13. The method of claim 11 wherein the user carries a portable, wireless device within communications range of the automated retailing and distribution system and, optionally, provides additional input to indicate a desire to connect the portable, wireless device to the automated retailing and distribution system.

14. The method of claim 8 wherein, following connection of the automated retailing and distribution system with the user's portable device, the automated retailing and distribution system downloads information from the user's portable device to facilitate transfer of digitally-encoded content from the automated retailing and distribution system to the portable device.

15. The method of claim 14 wherein the information downloaded from the user's portable device may include:
a device type;
a device model number;
a device manufacturer;
a list of digitally-encoded content currently stored on the portable device;
digitally-encoded user preferences; and
a device certificate to facilitate secure transfer of digitally-encoded data.
